(19) United States
(12) Patent Application Publication
(10) Pub. No.: US 2016/0368578 A1
(43) Pub. Date: Dec. 22, 2016

(54) Imaging System for Watercraft and Trailers

(71) Applicant: Gary L. Walke, Bondurant, IA (US)

(72) Inventor: Gary L. Walke, Bondurant, IA (US)

(21) Appl. No.: 15/180,389

(22) Filed: Jun. 13, 2016

Related U.S. Application Data
(60) Provisional application No. 62/180,661, filed on Jun. 17, 2015.

(51) Int. Cl. B63B 49/00; B63C 3/00; H04N 5/33; H04N 7/18; H04N 5/247; B60R 1/00; H04N 5/225

(52) U.S. Cl. CPC B63B 49/00; B60R 1/002; B63C 3/00; H04N 5/2253; H04N 7/181; H04N 5/247; H04N 5/332; B60R 2300/808

(57) ABSTRACT

A method and apparatus using a camera and image display for improving navigation of watercraft is presented. The system may be used by a helmsman to view regions outside his unaided sight range. Objects ahead of and behind the watercraft, both above and beneath the surface, may be detected and navigation decisions are made thereby. The same method and apparatus may be used to improve the view in backing a trailer. In any case, the images may be recorded for later viewing.

### CROSS REFERENCE TO RELATED APPLICATIONS

Priority is hereby claimed to U.S. Provisional Patent No. 62/180,661, filed Jun. 17, 2015, entitled BOAT/WATERCRAFT LOADING AND BOAT/WATERCRAFT/TOWED ITEM TRAILERING CAMERA SYSTEM, which describes the present invention and is hereby incorporated by reference in its entirety.

### BACKGROUND OF THE INVENTION

Field of the Invention

The present invention relates generally to an imaging system to assist in navigation of a boat or watercraft. In particular, the system aids in aligning the watercraft to a trailer when loading, permits examining the structure or shoreline while operating a watercraft from a view that cannot be seen unaided from the operating position (helm) of the watercraft, provides a view behind a trailered watercraft—or any other trailered item—while towing and underway, permits a view to stern while facing toward the bow while operating a watercraft.

Background Art

There are many applications of back-up camera systems in the marketplace. These systems help solve the issues associated with backing a vehicle to attach to a trailer for towing purposes. These systems also offer the vehicle driver additional viewing area in the back or around the towing vehicle for viewing their surroundings in order to operate the vehicle safely. These systems increase the ability to operate the vehicle safely to prevent damage to the vehicle, their surroundings, or other persons.

There are also systems available as either an OEM vehicle option or as an aftermarket kit to permit viewing behind a towed vehicle. These systems also increase the ability to operate the vehicle safely to prevent damage to the vehicle, their surroundings, or other persons.

These systems do not offer any means to provide viewing of the trailer or surroundings during the loading of a trailered watercraft or other driven loaded item. These systems do not provide for viewing ahead of the craft while underway.

These systems do not offer a means to provide viewing to the rear of a watercraft to view towed items or people or traffic behind while facing forward. These systems also do not permit recording of backward-facing video for future viewing.

There is, therefore, a need for an imaging method and apparatus for providing forward and rearward imaging from a watercraft or boat.

### BRIEF SUMMARY OF THE INVENTION

An object of the present invention is to provide a method and apparatus for viewing images of surroundings about a watercraft under various circumstances.

For the purposes of the instant application, the terms boat and watercraft are hereby defined as synonymous. Any craft intended to be used on the water such as a fishing boat, canoe, speed boat, pontoon boat, raft, dinghy, jet ski, barge, etc., is considered a boat or watercraft for this document, including the claims.

As with all vehicles, it is required that boats and trailers be operated at times in a forward direction and at other times in a rearward direction. For the purposes of the present document, including the claims, forward is hereby defined as the usual direction of operation, especially when travelling long distances. For watercraft, forward is the direction toward the bow of a watercraft. For a trailer, forward is toward the tongue of the trailer. For an automobile, it is the usual direction faced by the driver. Rearward and backward are hereby defined as synonyms, as are rear and back. Rearward or backward is the direction opposite the forward direction. Rearward or backward is toward the stern of a watercraft, opposite the tongue of a trailer, and opposite the usual direction faced by the driver of an automobile.

For the purposes of this document, camera is defined as a device for producing an image. The image produced by the camera may be pictorial, graphical, digital, or analog. It may be produced using natural or artificial light in the visible, infrared, or ultraviolet frequencies, x-rays, microwaves, radar, etc. The image may be still or exhibit motion (a video). The image may be processed to clarify, focus, zoom in or out, for edge detection, to correct for refraction, etc.

In a first embodiment of the present invention, a camera is placed at the front of the watercraft. The camera is aimed to provide a video feed of a region in front of the watercraft that cannot be fully seen by the operator of the watercraft from the operational point, usually the helm of the watercraft. The image provided by the camera is displayed on an image display or screen within view of the watercraft operator. The image may be displayed on a stationary or mobile device, wired or wireless. The image is, understandably, useful when the watercraft underway. This view of the front, or bow area, of the craft can be helpful to examine the forward surroundings while navigating otherwise unseen structures such as stumps, debris, or buoys, or approaching the shoreline for docking or beaching a watercraft.

Using diverse wavelengths of electromagnetic waves, objects under the water's surface may be detected, even though the camera is above the water's surface, and an image of the object or objects may be constructed to warn the helmsman.

A second embodiment utilizes a camera mounted in the stern area of the watercraft. The display is, again, in view of the helmsman at his operating position. This display or screen may be the same one used for the bow-mounted camera image, where the two images are displayed simultaneously or by selection, or the image display may be independent of the screen used for the bow mounted camera image.

This system of this second embodiment permits safer backing of the watercraft. It also may be used to view towed items and/or persons. This is especially useful for viewing the condition of a person or persons on a towable item such as a towable floatation tube, ring, or sled, water skis, or wakeboard. This view would allow the boat/watercraft operator to face forward for safe operation of the watercraft while glancing at the towed item and/or persons on the image display.

A third embodiment of the instant invention utilizes a rear-mounted camera mounted to the stern of the watercraft when towed by another vehicle—over land or on the water. The image is then displayed in view of the operator of the towing vehicle. This system increases the safety of the vehicle and towed item to prevent damage to the vehicle, towed item, the surroundings, other vehicles, and/or persons while traveling.

Any of the above embodiments may incorporate one or more dedicated image display screens. Said screens may communicate with the camera either via hardwire or wireless technology. Additionally, the image or video captured by the camera may be received and viewed on a mobile or cellular telephone using known communication methods such as Bluetooth, b/g/n wireless, etc. A cellular telephone used as the image display or screen permits the device to be easily transported to desired viewing areas. The telephone may receive image or video transmission from the bow- or stern-mounted cameras, either at the watercraft operating position (boat helm), or within the towing vehicle, or at any other location within transmission range. Any number of cellular telephones may be used to view any of the mounted cameras. For example, a boat passenger may wish or need to face forward while the boat is underway and utilize a telephone screen to watch the towed item or persons behind the boat. Additionally, while viewing the moving images on the cellular telephone screen, a phone application may be used to record the video feed. Lastly, the use of a cellular telephone for the image display device may reduce cost for the entire system.

The novel features believed to be characteristic of this invention, both as to its organization and method of operation together with further objectives and advantages thereto, will be better understood from the following description considered in connection with the accompanying drawings in which a presently preferred embodiment of the invention is illustrated by way of example. It is to be expressly understood however, that the drawings and examples are for the purpose of illustration and description only, and not intended in any way as a definition of the limits of the invention.

### BRIEF DESCRIPTION OF THE SEVERAL VIEWS OF THE DRAWINGS

FIG. 1 depicts a perspective view of a watercraft preparing to be loaded onto a boat trailer at a typical boat ramp.

FIG. 2 illustrates a perspective view of the watercraft underway as it approaches objects in the water.

FIG. 3 shows a perspective view of the watercraft operating while underway as it approaches objects along the shoreline;

FIG. 4 depicts a side elevation view of the watercraft loaded on a trailer and the trailer hitched to a towing vehicle;

FIG. 5 illustrates a side elevational view intended to show the limited sight of a vehicle operator from the vehicle's operating position;

FIG. 5A shows a top plan and cutaway view of a towing vehicle cabin;

FIG. 5B depicts what may be seen by a towing vehicle driver in a vehicle's inside rearview mirror;

FIG. 5C illustrates what may be seen by a towing vehicle driver in a vehicle's passenger-side rearview mirror;

FIG. 6 shows a side elevation view of a watercraft fitted with the imaging system of the present invention wherein the camera is hardwired to the display screen;

FIG. 7 depicts a side elevation view of a watercraft fitted with the imaging system of the present invention wherein the camera and display screen communicate wirelessly;

FIG. 8 illustrates a side elevation view of a watercraft disposed onto a trailer, said trailer being hitched to a towing vehicle, the camera and image display system in wired communication;

FIG. 9 shows a side elevation view of a watercraft disposed onto a trailer, said trailer being hitched to a towing vehicle, the camera and image display system in wireless communication;

FIG. 10 depicts a watercraft towing a water skier, the imaging system of the present invention permitting the helmsman a rearward view;

FIG. 11 illustrates a plurality of cameras and image display devices being used on a single watercraft;

FIG. 12 shows the watercraft, trailer, and towing vehicle, the imaging system of the present invention providing images from forward and rearward of the watercraft;

FIG. 13 depicts a side elevation view of the watercraft with the camera hardwired to the image display device and mounted under the surface of the water for a view of submerged objects;

FIG. 14 illustrates a side elevation view of the watercraft with the camera communicating with the image display device via wireless technology and mounted under the surface of the water for a view of submerged objects;

FIG. 15 shows submerged objects as captured by the camera of the present invention mounted under water; and

FIG. 16 shows submerged objects as captured by the camera of the present invention mounted above water.

### DETAILED DESCRIPTION OF THE INVENTION

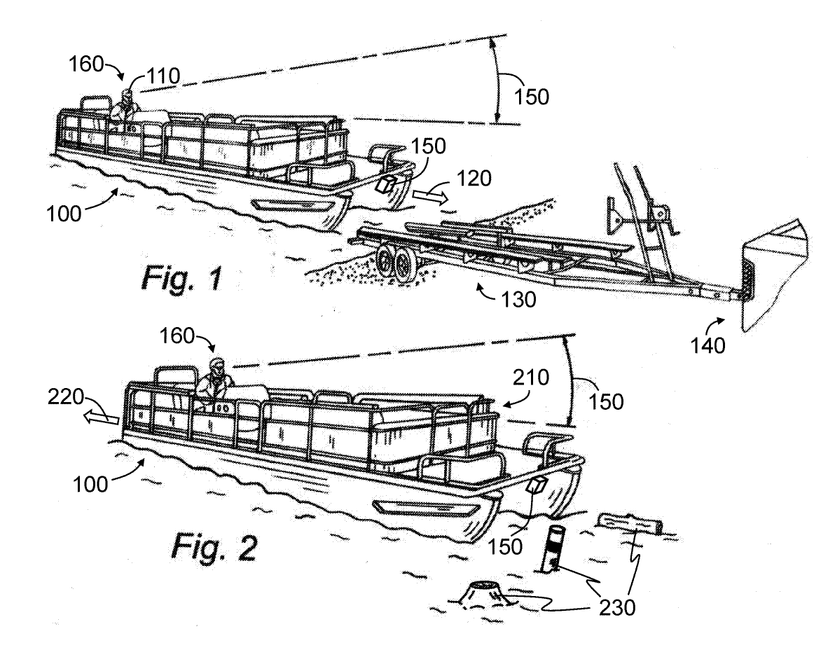

Referring now to the drawings wherein like reference numerals indicate identical or corresponding parts throughout the several views, a watercraft 100 is shown in FIG. 1 operated by a pilot, helmsman, or operator 110 and moving in a generally forward direction 120. The purpose illustrated in FIG. 1 is to load the watercraft 100 onto a trailer 130, hence making transport possible via a towing vehicle 140. Note, however, the helmsman's 110 unaided line of sight is limited by the watercraft 100, itself. The operator's 100 field of vision is indicated by the region 150 shown in FIG. 1. In order to view the region off the bow of the watercraft 100, the helmsman must stand up or leave the operating position or helm 160.

The addition of a camera 150, disposed in the vicinity of the bow of the watercraft 100 enables a much more complete view of the region forward of the watercraft 100.

During typical operation of a watercraft 100, the boat operator 110 often cannot see what is directly in front of the craft as his field of vision is obstructed by the length of the watercraft 100 in front of the helm 160. The boat operator 110 may rely on aligning the craft with a boat trailer 130 by visually aligning a boat sight point with a sight point on the boat trailer 130. Alternatively, in the case the boat operator 110 is not alone, the helmsman 110 relies upon others. The other persons may be on the watercraft 100 and can see in front of the watercraft 100 from their viewing position, or may be on shore at the trailer 130 to offer assistance. This communication to the boat operator 110 from the other persons can sometimes be misunderstood or not heard by the boat operator 110. The interpretation of the information by the boat operator 110 can be incorrect and result in poor operational results. In some cases there may be one or more persons assisting the boat operator, so “boat operator” is defined as a person or persons operating the boat or helping the primary operator to operate the boat, which person helping the primary operator can be just a passenger on the boat at other times.

In a typical boat 100 loading situation, that is, removing the watercraft 100 from the body of water and placing it on the trailer 130, the tow vehicle 140 backs the trailer 130 partially into the water. The boat 100 then approaches the boat trailer 130 from the water, aligning the boat 100 with the trailer 130 for proper loading. The configuration of watercraft 100, boat trailers 130, and boat ramps vary widely. As can be seen from FIG. 1, the boat operator 110 often cannot see the trailer 130 during the final approach of the boat 100 to the trailer 130 in the loading process. The boat operator's 110 field of vision 150 often does not include the rear portion of the trailer 130 during this process. This inability to see where the front of the watercraft 100 is relative to the rear of the trailer 130 during the final stages of the loading process can result in misalignment of the boat 100 with the trailer 130. The misalignment of the boat 100 and trailer 130 results in an unsuccessful load and requires at least one subsequent attempt to reload. Sometimes the misalignment can result in damage to the watercraft 100, boat trailer 130, or even bodily harm to surrounding persons. In any case, there is advantage to avoiding misalignment.

FIG. 2 depicts the watercraft 100 while underway. The rearward direction 220 is shown in this view. While underway the boat operator's 110 view in front of the bow of the watercraft 100 often is obstructed by the length of the watercraft 100, railings 210, cargo boxes, chairs, etc., in front of the operating position 160. In the case an operator 110 is alone, boat safety may be compromised. In the case the boat operator 110 is not alone, the helmsman 110 often relies upon others. The other person(s) on the watercraft 100 may be disposed on the watercraft 100 such that their view off the bow is not hindered. Hence, such person(s) may warn the helmsman 110 of obstacles or objects 230 in the water ahead. This requires the passenger(s) to be attentive to the water ahead. Communication to the boat operator 110 from the other person(s) can sometimes be misunderstood or not heard by the boat operator 110. The interpretation of the information by the helmsman 110 can be incorrect and result in poor operational results.

Again, the addition of a camera 150, disposed in the vicinity of the bow of the watercraft 100 enables a much more complete view of the region forward of the watercraft 100, largely negating the disadvantages of operating a watercraft 100 alone or relying on one or more passengers to warn the helmsman 110 of obstacles 230 in the waters off the bow of the watercraft 100.

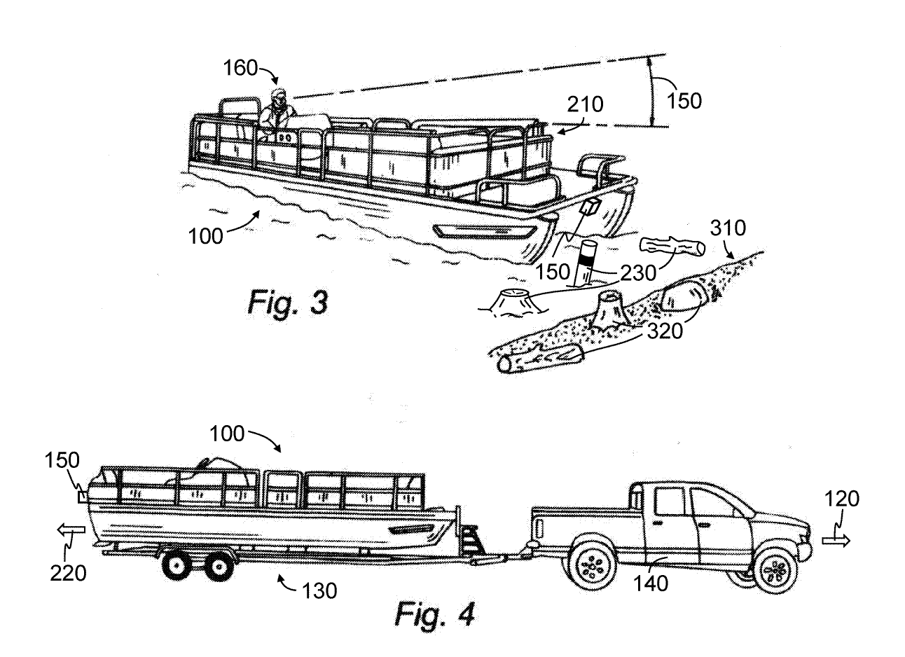

For identical reasons as given above, when approaching a shoreline 310 or a dock (not shown), as shown in FIG. 3, the boat operator's 110 view directly in front of the craft is often obstructed by the length of the watercraft 100, railings 210, cargo boxes, chairs, etc., in front of the operating position 160. Just as above regarding objects 230 in the water and objects on the shore 320, these limitations may result in poor watercraft 100 beaching. As a consequence of the boat operator's 110 limited view, 150, there is danger to the watercraft 100, the boat operator 110, watercraft occupants 1120 (see FIG. 11), and objects in the water 230 and objects on the shore 320 due to the boat's 100 impacting those unseen objects. Even the shoreline 320 itself can cause damage or injury to the watercraft 100, the boat operator 110, and watercraft occupants if the watercraft 100 impacts the shoreline 320 at too great a speed. In some cases, the shoreline 310 may be damaged as well.

Again, the addition of a camera 150, disposed in the vicinity of the bow of the watercraft 100 enables a much more complete view of the region forward of the watercraft 100, largely negating the disadvantages of attempting to beach a watercraft 100 alone or relying on one or more passengers to aid the helmsman 110 in beaching the watercraft 100.

FIG. 4 depicts a watercraft 100 in towing mode during transport. Towing involves the trailer 130 and the towing vehicle 140. The drawing illustrates the distance the watercraft 100 and trailer 130 extend behind the towing vehicle 140. The forward direction 120 and the reverse or rearward direction 220, as defined above, are illustrated by arrows in FIG. 4.

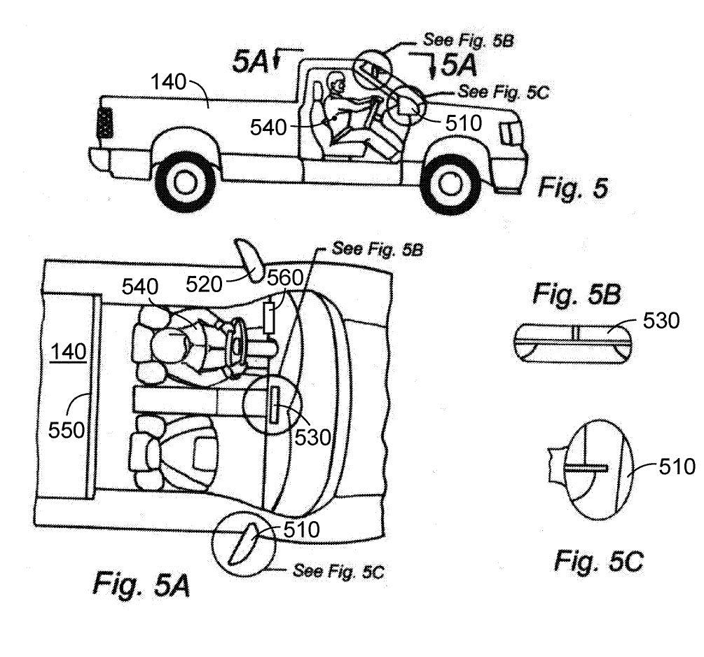

As shown in FIG. 4, the uncertainties of backing a long trailer may be mitigated by the addition of a camera 150 at the rear of the towed watercraft 100 or trailer 130. Of course, the image display must be in view of the towing vehicle 140 driver 510 (see FIG. 5A).

FIGS. 5, 5A, 5B, and 5C help highlight the deficiencies associated with using various vehicle mirrors 510, 520, 530 and windows to see behind while towing and backing towed items. Often the watercraft 100 itself blocks the vehicle driver's 540 view of the road or surroundings behind. This inability to view what is behind the towed watercraft 100 can result in damage to the watercraft 100, boat trailer 130, surroundings, such as other vehicles, buildings, signposts, etc., or even persons during transport. This lack of being able to see behind is especially hindering when the item is backed.

FIGS. 5 and 5A illustrate the driver 540 inside the towing vehicle 140 in a towing vehicle operator's position. The driver 540 has visual access to a passenger-side rearview mirror 510, a driver's side rearview mirror 520, and an inside rearview mirror 530, as well as the rear windshield 550.

FIG. 5B shows what might be seen in the inside rearview mirror 530 from the towing vehicle operator's position. The region behind the towed watercraft or other item is often not visible in this inside rearview mirror 530.

FIG. 5C depicts what might be seen in the passenger side rearview mirror 510 from the towing vehicle operator's position. The region behind the towed watercraft or other item is often not visible in this passenger side rearview mirror 510. The view from the driver's side rearview mirror is not illustrated, notwithstanding, the region behind the towed watercraft or other item is often not visible in the driver's side rearview mirror.

Based on the illustrated inability to view the rear of the towed item via the usual mirrors and rear windshield, mounting the camera 150 at or near the rear of the towed item, as shown in FIG. 4, provides the driver 540 a view of an important region, especially when backing the towed item. The image display device or screen 560 is shown in the vicinity of the dashboard inside the towing vehicle 140, but said screen 560 may be disposed anywhere convenient and visible to the driver 540.

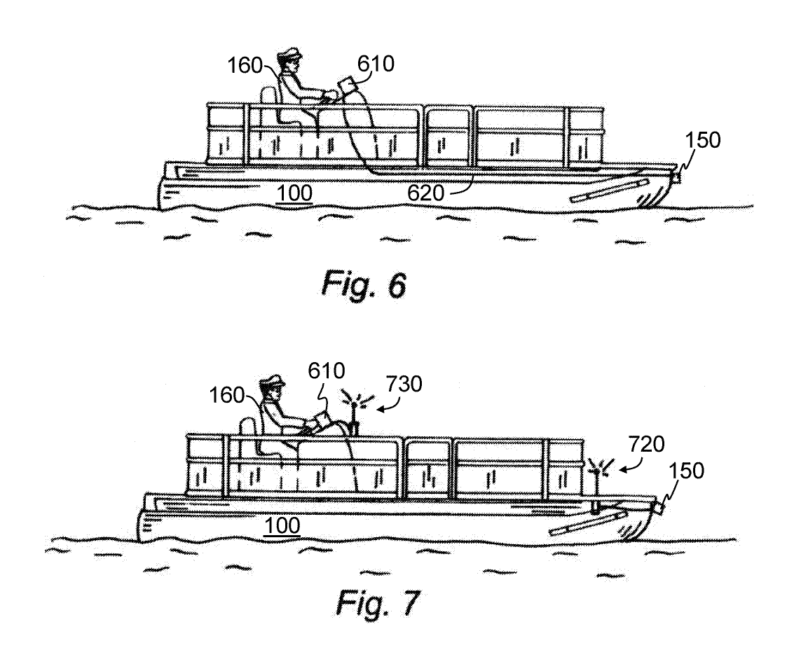

The watercraft 100 detailed in FIG. 6 shows an example configuration of the imaging system of the present invention. The camera 150 is situated in the vicinity of the bow of the watercraft 100. The positioning and mounting of the camera 150 will vary with different boat 100 configurations such as pontoon boat, V-bottom boat, flat bottom boat, canoe, raft, barge, etc. The positioning of the camera 150 is critical to proper operation of the camera 150 and screen 610 system. Note that the screen or image display device 610 is separate and remote from the camera 150. The boat operator 160 must be able to view the position of the boat 100 bow accurately. Therefore the camera 150 is preferably positioned as close to the center between the port and starboard sides on the watercraft 100, and in a horizontal position to the water or shore horizon. The mounting of the camera 150 must be sufficiently mechanically flexible to accommodate different boat 100 configurations and camera 150 orientations. FIG. 6 details a wire 620 connecting the camera 150 and screen 610.

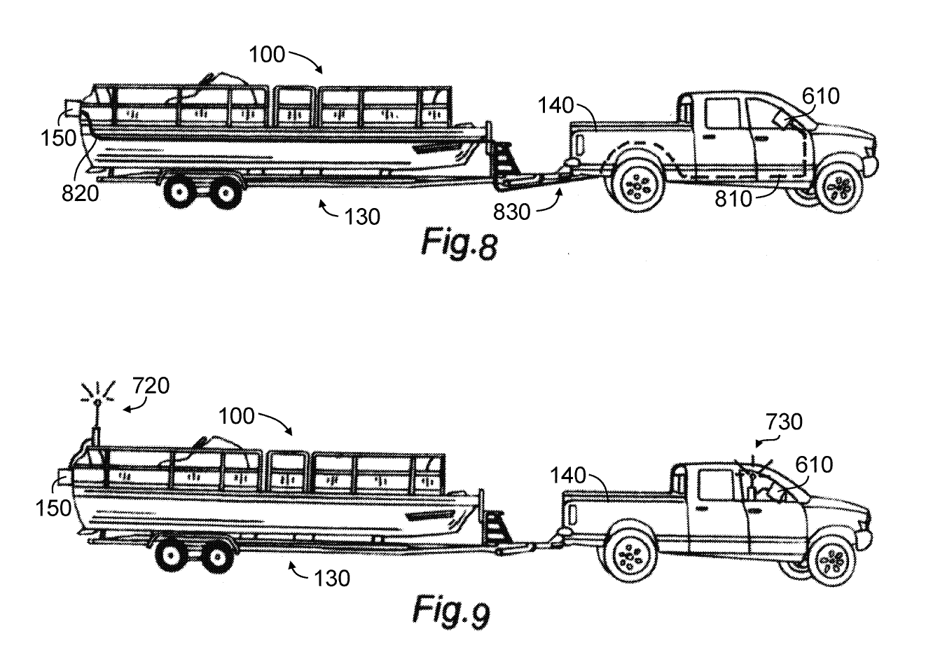

In FIG. 7, the camera 150 and screen 610 are shown connected in a wireless fashion as indicated by the transmitter 720 sending a signal from the camera to the receiver 730 by which the image or video is received and displayed on the image display 610. The wireless connection from transmitter 720 to receiver 730 may be accomplished using numerous communication means or protocols, such as Bluetooth, b/g/n wireless, etc., across the communication spectrum. The present invention is not limited to a particular communication protocol. One advantage to the wireless mode of connecting the camera 150 and screen 610 is the ease at which the camera 150 may be repositioned, for example from the bow to the stern of the watercraft 100.

FIG. 8 depicts an example configuration of the towing vehicle 140 disposed to tow a watercraft 100 and trailer 130. In this configuration, the camera 150 is disposed in the vicinity of the stern of the watercraft 100 or the rear of the trailer 130. The image display device 610 is located in the cab of the towing vehicle 140 in view of the driver 540 (not shown).

In this example, a wired connection between the camera 150 and the screen 610 inside the towing vehicle is used. Typically, a wiring system 810 is used to carry the signal within the towing vehicle 140 and another wiring system 820 is used to carry the signal the length of the watercraft 100 or trailer 130. The two wiring systems 810, 820 are preferably connected near the trailer hitch 830 using connectors that may be easily disconnected when the trailer 130 is disconnected from the towing vehicle 140. The two wiring systems 810, 820 may be permanently installed in their respective locations, or strung when needed.

In FIG. 9, the camera 150 and image display 610 communicate wirelessly. As in FIG. 7, the camera 150 is associated with a transmitter 720 while the image display 610 is associated with a receiver 730. The wireless connection from the transmitter 720 to receiver 730 may be accomplished using numerous communication means or protocols well known by those of ordinary skill.

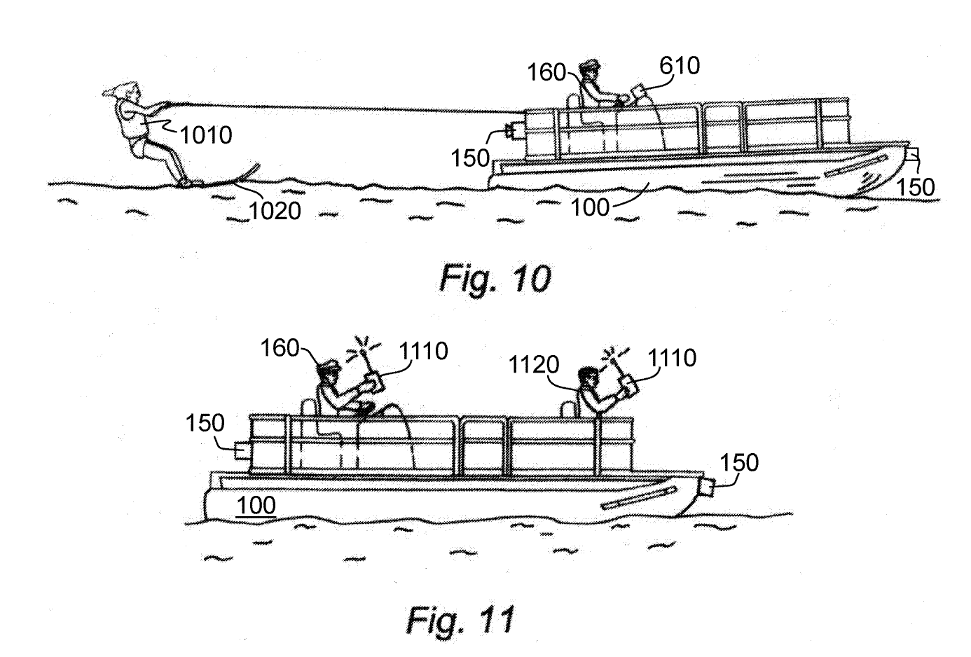

The camera 150 is mounted in the region of the stern of the watercraft 100 in FIG. 10. The image display 610 is disposed on the watercraft in the vicinity of the helm or operating position where the helmsman 160 may view it. This system allows viewing of the towed item, such as another boat 100, or person 1010 or persons without requiring the helmsman 160 to turn around. This is especially useful for viewing the condition of a person 1010 or persons on a towable item such as a towable floatation tube, ring, sled, water skis 1020, or wakeboard.

In the same instance, another camera 150 may optionally be mounted to the front of the watercraft 100. In this instance, the image display device 610 must be configured to display a plurality of images, either simultaneously or alternately, by command. Another option is to provide an image display device 610 for each camera 150 used.

A plurality of cameras 150 and a plurality of cellular telephones 1110 are shown utilized on the watercraft 100 in FIG. 11. In this example, a passenger 1120 is monitoring one of the cellular telephones 1110. However, each of the cellular telephones 1110 may be configured to receive images or videos from either or both of the cameras 150. Hence, all parties with cellular telephones 1110 may view the images or videos from any camera 150.

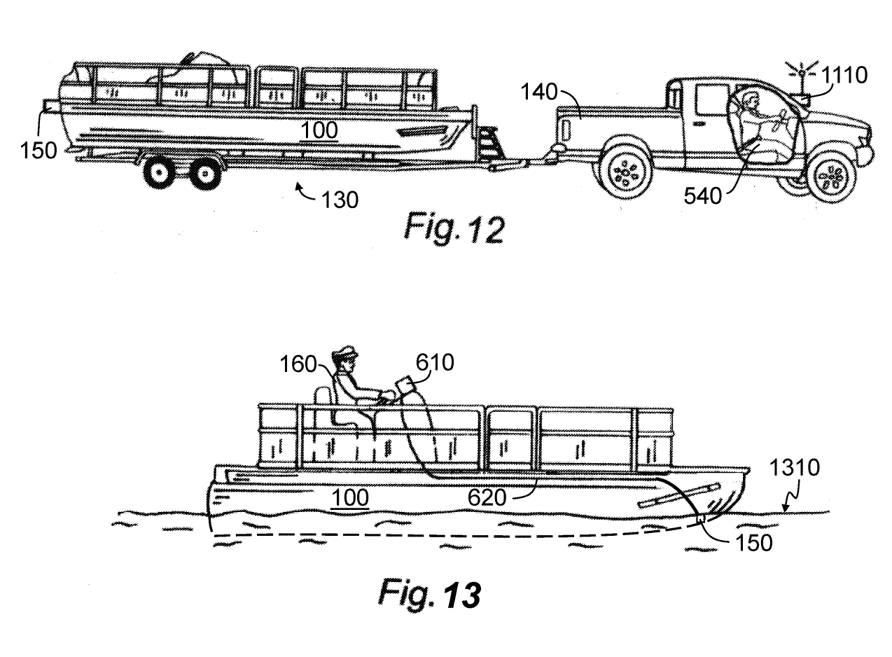

FIG. 12 depicts the watercraft 100 mounted on the trailer 130 disposed to be towed by the towing vehicle 140. In this figure, the image display device is a mobile or cellular telephone 1110. This arrangement permits flexibility for the video screen placement. The cellular telephone 1110 platform provides increased processing power over a simple video screen 610, allowing for software or applications to extend the system's usefulness. The processing power of the cellular telephone 1110 platform can also provide capability for recording images or videos provided by the cameras 150 for future playback. By using the user's own cellular telephone 1110 the system may also be less costly.

For the purpose of viewing under water, in one embodiment of the present invention, the camera 150 may be disposed on the watercraft 100 under the surface 1310 of the water, as depicted in FIG. 13 Like the configuration of FIG. 6, the camera 150 and the screen 610 communicate via a wired system, using wire 620 connecting the camera 150 and the screen 610.

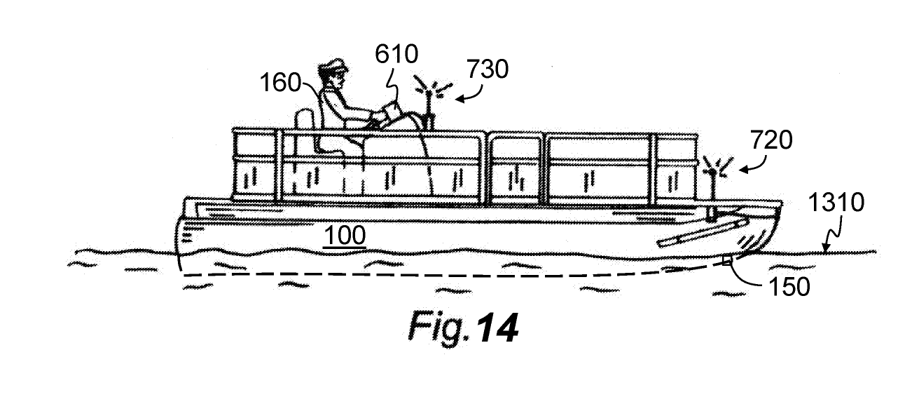

In a second embodiment for viewing under the water's surface 1310, the camera 150 is, again, mounted on the watercraft 100 under the surface 1310 of the water in FIG. 14. As in FIG. 7, the camera 150 and screen 610 are connected in a wireless fashion as indicated by the transmitter 720 sending a signal from the camera to the receiver 730 by which the image or video is received and displayed on the image display 610. The wireless connection from transmitter 720 to receiver 730 may be accomplished using numerous communication means or protocols, such as Bluetooth, b/g/n wireless, etc., across the communication spectrum. The present invention is not limited to a particular communication protocol.

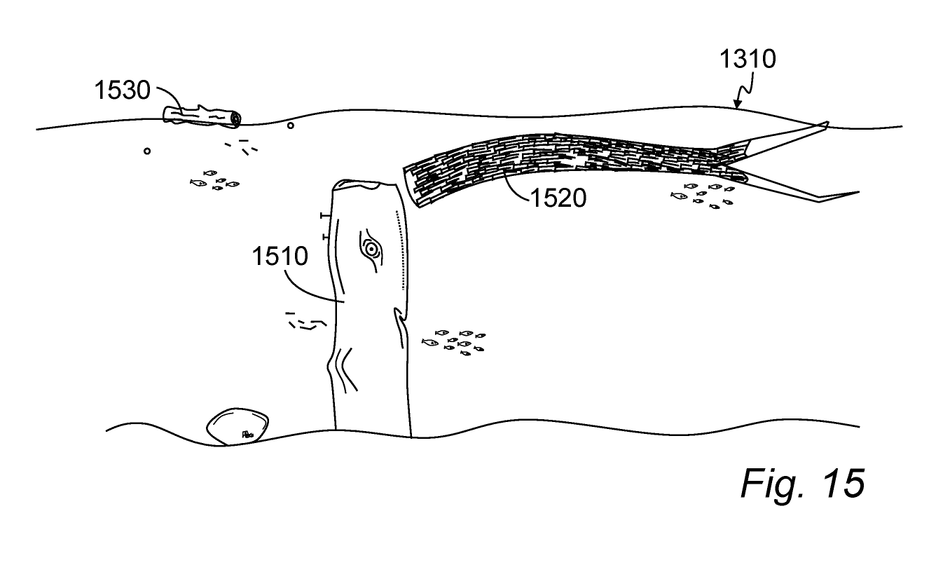

A purpose for viewing under the water's surface 1310 is to provide awareness of submerged objects and obstacles that may damage the watercraft 100 or injure towed persons 1010. A view above and under the water's surface 1310 is illustrated in FIG. 15. Typical objects of interest under water are stationary objects, such as former structures 1510 such as pier, dock, or bridge pilings. Also, floating objects, such as tree limbs or trees 1520 that are suspended under the surface and are therefore difficult to see from above the water's surface 1310. Above the surface, the camera 150 may detect floating objects 1530, as related above. Objects 230 above the water's surface 1310 and objects 1510, 1520 represent a danger to the watercraft 100, the watercraft's operator 110, other boat occupants 1120, and the objects 230, 1510, 1520 if such objects are struck by the watercraft, 100.

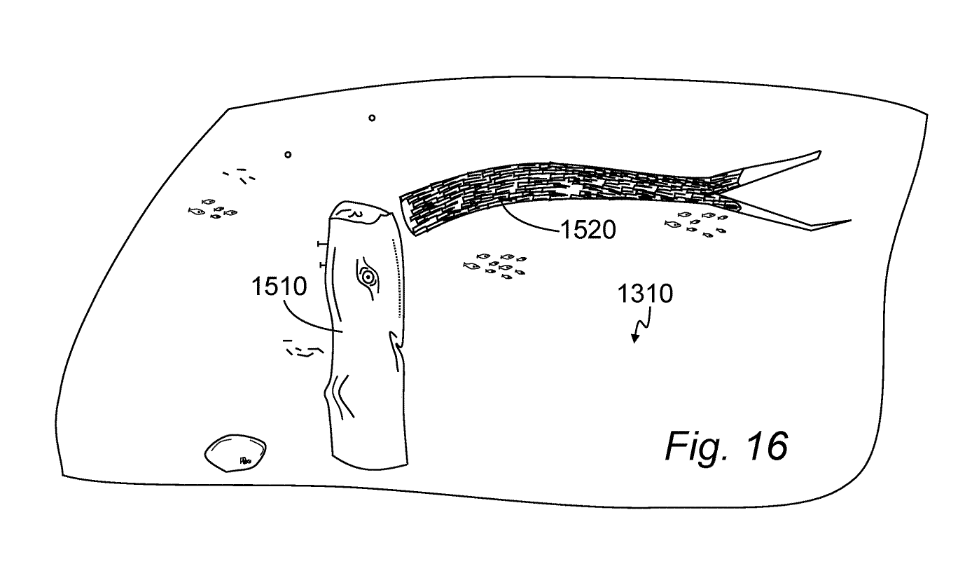

Another embodiment of the present invention calls for the camera 150 to be mounted above the water's surface 1310, but to be capable of capturing images under water. Such a view is shown in FIG. 16 where, again, obstructions may include stationary objects, such as former structures 1510 such as pier, dock, or bridge pilings and floating objects, such as tree limbs or trees 1520 that are suspended under the surface. For this image, light in its visible spectrum (about 390 to 700 nanometers wavelength) may not be used solely. Other wavelengths of electromagnetic waves, such as radar, X-rays, or microwaves may be better suited to penetrate the water's surface. Hence, image processing to provide a visible, clear image for the viewer may be necessary. Also, distortion due to refraction may be present, and image processing may be required to adjust for that distortion.

The above embodiments are the preferred embodiment, but this invention is not limited thereto, nor to the figures and examples given above. It is, therefore, apparent that many modifications and variations of the present invention are possible in light of the above teachings. It is, therefore, to be understood that within the scope of the appended claims, the invention may be practiced otherwise than as specifically described.

1. A method of improving watercraft navigation using an image producing camera, said method comprising:
(a) mounting the camera on the watercraft;
(b) disposing the watercraft in water;
(c) acquiring at least one image from the camera, said image not within an unaided view of a helmsman operating the watercraft;
(d) transmitting said at least one image to an image display device, said image display device being separate and remote from the camera;
(e) displaying said at least one image on the image display device; and
(f) disposing the image display device in view of the helmsman.

2. The method of claim 1 wherein acquiring the at least one image comprises acquiring depictions of objects at a location selected from the group consisting of above a surface of the water and beneath the surface of the water.

3. The method of claim 1 wherein mounting the camera on the watercraft comprises mounting the camera at a location selected from the group consisting of above a surface of the water and beneath the surface of the water.

4. The method of claim 1 wherein mounting the camera on the watercraft comprises mounting the camera above a surface of the water and acquiring the at least one image comprises acquiring depictions of objects beneath the surface of the water.

5. The method of claim 1 additionally comprising the helmsman making a navigation decision based on the image.

6. The method of claim 4 additionally comprising using electromagnetic wave wavelengths other than those within a visible light spectrum to acquire the at least one image from the camera.

7. The method of claim 1 additionally comprising:
(a) disposing the camera in a vicinity of a bow of the watercraft;
(b) navigating the watercraft toward an object selected from the group consisting of a trailer and a shore;
(c) acquiring a plurality of images of a region between the watercraft and the object; and
(d) adjusting a trajectory of the watercraft based on the images.

8. The method of claim 1 additionally comprising:
(a) disposing the camera in a vicinity of a stern of the watercraft;
(b) towing at least one object behind the watercraft; and
(c) the helmsman viewing the at least one image of a region to a rear of the watercraft while facing toward a front of the watercraft.

9. The method of claim 1 wherein transmitting the image to an image display device comprises transmitting the image using a protocol selected from the group consisting of wired and wireless protocols.

10. The method of claim 1 additionally comprising recording a plurality of images.

11. The method of claim 1 additionally comprising:
(a) mounting a second camera on the watercraft;
(b) acquiring a second at least one image from the second camera;
(c) transmitting said second at least one image to the image display device, said image display device being separate and remote from the second camera;
(d) displaying said at least one image and the second at least one image on the image display device.

12. A method of improving backing a trailer using a camera, said method comprising:
(a) operatively connecting a towing vehicle to the trailer;
(b) disposing the camera in a vicinity of a rear of the trailer;
(c) acquiring at least one image from the camera, said image not within an unaided view of a towing vehicle driver;
(d) transmitting said image to an image display device, said image display device being separate and remote from the camera; and
(e) disposing the image display device in view of the towing vehicle driver.

13. The method of claim 12 additionally comprising:
(a) disposing an item on the trailer; and
(b) mounting the camera on the item.

14. The method of claim 13 wherein the item is a watercraft.

15. The method of claim 12 wherein transmitting the image to an image display device comprises transmitting the image using a protocol selected from the group consisting of wired and wireless protocols.

16. An apparatus for improving watercraft navigation, said apparatus comprising:
(a) a camera mounted to the watercraft to capture images not within an unaided view of a watercraft operator; and
(b) an image display device, separate and remote from the camera, said image display device disposed in view of the watercraft operator.

17. The apparatus of claim 16 additionally comprising:
(a) a transmitter for sending the images from the camera; and
(b) a receiver for receiving the images for display on the image display device.

18. The apparatus of claim 17 additionally comprising protocol for communicating the images from the transmitter to the receiver, said protocol being selected from the group consisting of wired and wireless protocols.

19. The apparatus of claim 16 wherein the camera is mounted in a vicinity selected from the group a bow of the watercraft and a stern of the watercraft.

20. The apparatus of claim 16 wherein the camera is mounted in a location selected from the group above a surface of a water and beneath the surface of the water.

21. The apparatus of claim 16 additionally comprising imaging capability in the camera using electromagnetic wave wavelengths other than a visible light wavelength spectrum.

22. The apparatus of claim 16 wherein the image display device is a cellular telephone.
